(19) United States
(12) Patent Application Publication
(10) Pub. No.: US 2007/0119656 A1
(43) Pub. Date: May 31, 2007

(54) Method of manufacture of ladder stabiliser

(76) Inventors: Jon Robert Scott, Queensland (AU); Andrew Anthony Richards, Queensland (AU)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/606,719

(22) Filed: Nov. 30, 2006

Related U.S. Application Data
(60) Provisional application No. 60/741,277, filed on Nov. 30, 2005.

(51) Int. Cl. E06C 1/00

(52) U.S. Cl. 182/200

(57) ABSTRACT

A method of forming a lug or spacer on a tubular housing of a ladder stabiliser for supporting a ladder. The lug or spacer is welded to an adjacent surface of the housing only at a top location and a bottom location respectively as a fillet weld. A ladder stabiliser having a tubular housing and a telescopic leg which is movable within a hollow bore of the housing. The telescopic leg has a plurality of holes for co-operating with a securing means to maintain the housing at a suitable height when in use for supporting the ladder. The telescopic leg is formed with an integral locating groove wherein each of the plurality of holes is located so that it is in the exact center width wise of the telescopic leg or coincides with a longitudinal axis of the hollow leg.

This invention relates to a method of manufacture of ladder stabilisers particularly a ladder stabiliser as disclosed in International Patent Publication WO 02/059446 which is incorporated by reference in its entirety.

International Patent Publication WO 02/059446 relates to a ladder stabiliser which supports a ladder, scaffolding or a trestle (herein generically referred to as “ladder”) on an uneven surface.

The stabiliser incorporates an inner member or telescopic leg having a plurality of holes which is telescopically engaged with a housing and thus movable within the housing and secured thereto at a desired location or hole by a securing means which involves a securing pin assembly having a knob or head, a casing, a spring and a pin as described in FIG. 5 of WO 02/059446. The pin is attached to the housing and extends through an adjacent aperture in the housing and through a selected hole in the telescopic leg to maintain the ladder at a desired height above the ground in use. Usually a pair of stabilisers support an adjacent upright of the ladder.

In use each housing of the pair of stabilisers is attached to an adjacent upright using a threaded attachment rod which extends through a hollow interior of an adjacent rung of the ladder and are retained in position by locking units engaging with the threaded rod at each end. In this regard there are provided hollow spacers which are integral with respective housings through which the threaded rod(s) may extend as shown in FIG. 3 of WO 02/059446.

It has now been discovered following manufacture of the ladder stabiliser as discussed above that the telescopic leg which preferably is of square cross section is a solid rod and difficulty has been experienced in relation to forming the plurality of apertures which extend through the rod transversely to a longitudinal axis thereof and provide satisfactory operation of the stabiliser in practice.

Also in relation to the formation of the abovementioned hollow spacers difficulty also has been experienced in establishing a suitable technique in attachment of the spacers to the housing so that the spacers are integral with the housing.

It is therefore an object of the invention to provide a method of manufacture of the stabiliser which may alleviate the difficulties or problems discussed above.

The invention therefore provides a ladder stabiliser which has a tubular housing and a telescopic leg which is movable within a hollow bore of the housing, said telescopic leg having a plurality of holes for co-operating with securing means to maintain the housing at a suitable height when in use for supporting a ladder, characterised in that said telescopic leg is formed with an integral locating groove wherein each of the plurality of holes is located so that they are in the exact centre width wise of the telescopic leg or coincide with a longitudinal axis of the hollow leg.

The invention also provides a method of manufacture of the abovementioned telescopic leg which includes the steps of:

(i) forming an initial groove in the telescopic leg which is made from solid rod; and

(ii) drilling a plurality of holes in the initial groove so that each of the holes have a centre which coincides with a longitudinal axis of the hollow leg.

In another aspect of the invention there is provided a method of forming a lug or spacer on a tubular housing of a ladder stabiliser for supporting a ladder, said lug or spacer being welded to an adjacent surface of the tubular housing only at a top location and bottom location respectively as a fillet weld which avoids deformation of the tubular housing and facilitates satisfactory operation of the stabiliser in use.

Reference may now be made to a preferred embodiment of the invention shown in the attached drawings wherein:

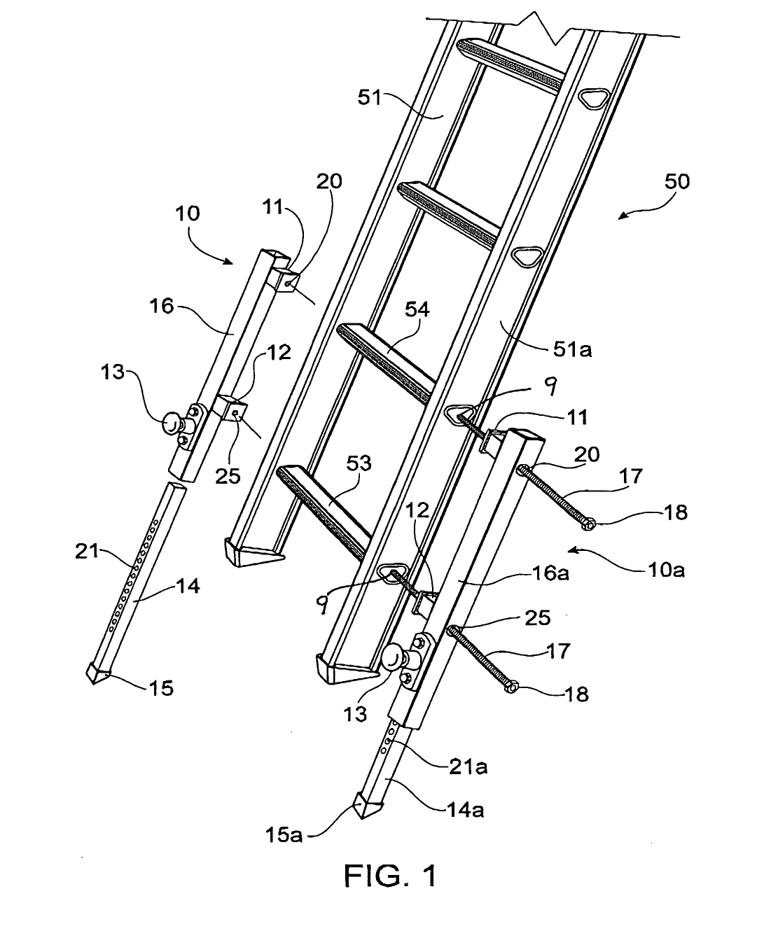

FIG. 1 is a perspective view of the ladder stabiliser of WO 02/059446 reproduced herein for convenience.

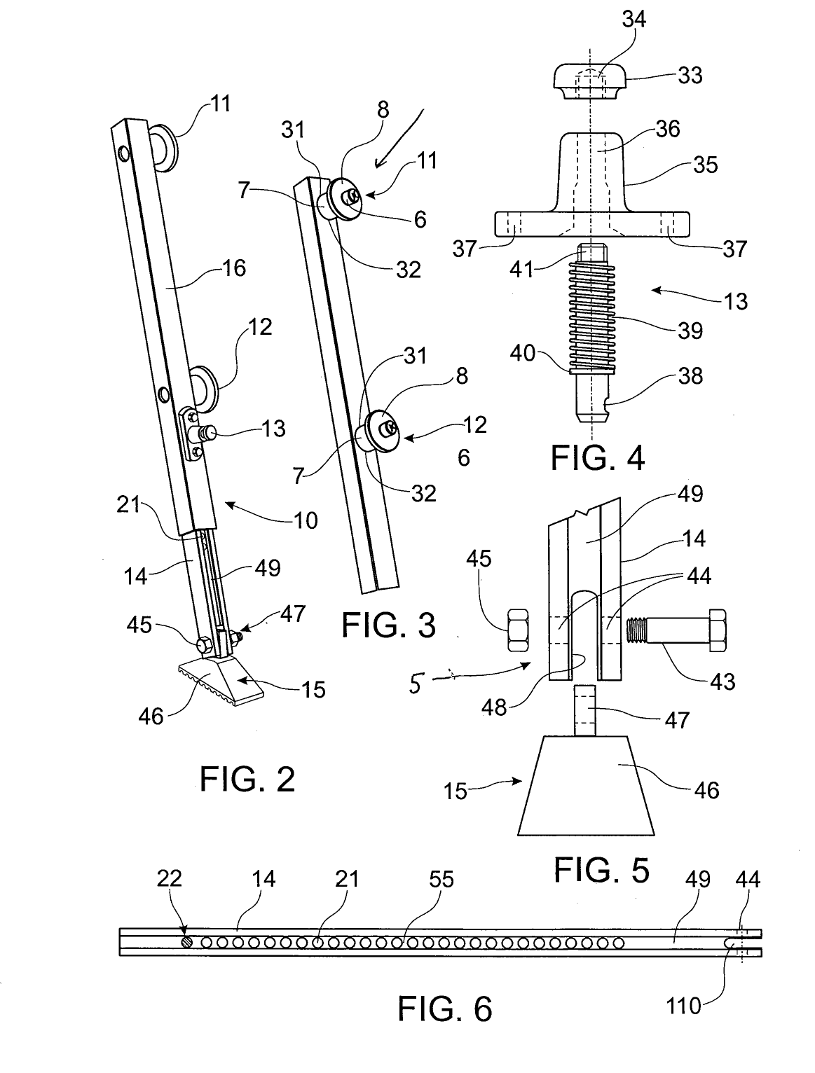

FIG. 2 is a perspective view of a single stabiliser shown in FIG. 1 omitting the ladder and other stabiliser for convenience.

FIG. 3 is a perspective view of the housing of the stabiliser shown in FIG. 1 or FIG. 2 showing the position of the fillet welds applied to each of the spacers;

FIG. 4 is an exploded view of the components of the pin assembly shown in FIG. 1;

FIG. 5 is a detailed view of attachment of the foot shown in FIG. 1 to the telescopic leg;

FIG. 6 is a plan view of the telescopic leg showing formation of an elongate groove which bounds the spaced apertures formed in the telescopic leg;

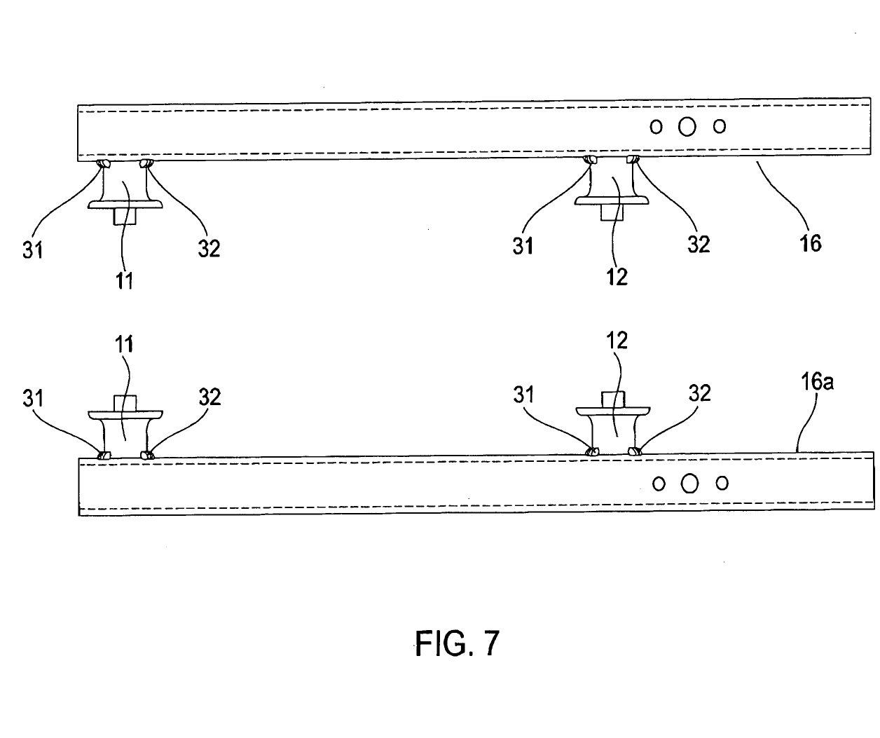

FIG. 7 is another view showing application of the fillet welds to the spacers of the tubular housing;

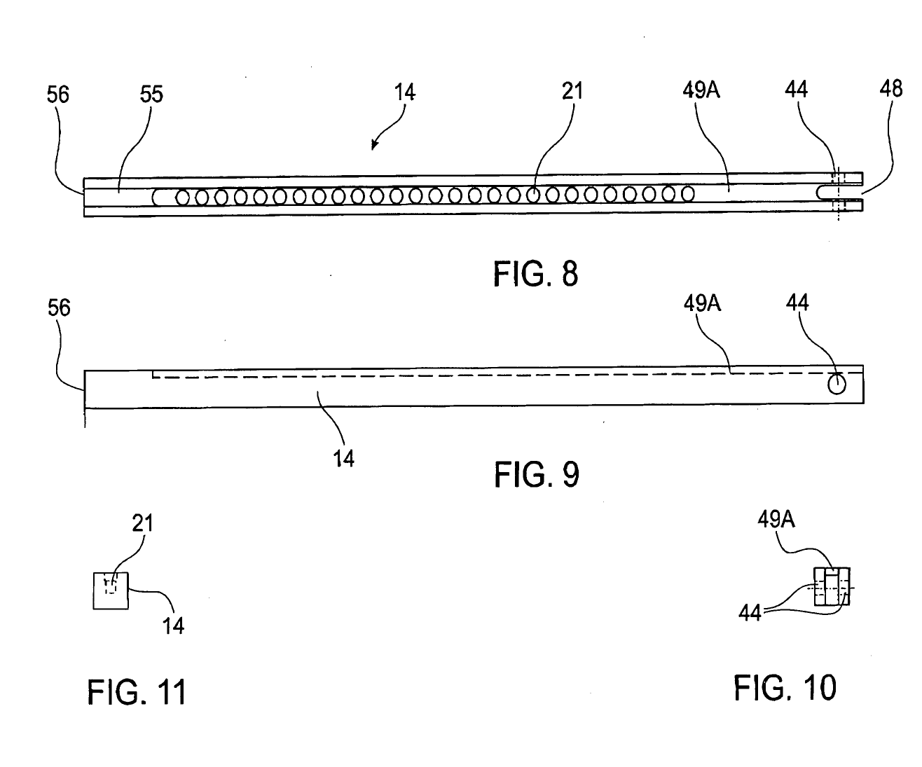

FIG. 8 is another plan view of the telescopic leg showing a different embodiment to that shown in FIG. 6;

FIG. 9 is a side view of the telescopic leg shown in FIG. 8;

FIG. 10 is a bottom end view of the telescopic leg shown in FIG. 8; and

FIG. 11 is a top end view of the telescopic leg shown in FIG. 8;

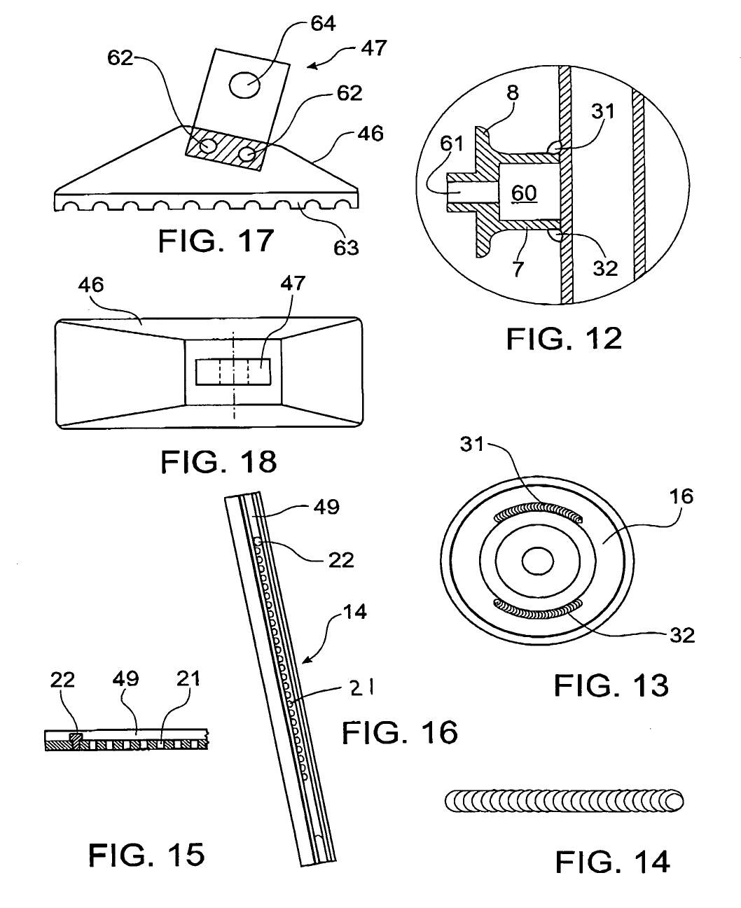

FIGS. 12 to 14 are detailed views of the welds formed between the spacer and the tubular housing;

FIGS. 15 to 16 show detailed views of the plug stop located in the locating groove; and

FIGS. 17 to 18 show detailed views of the foot.

In the drawings reference is made in FIG. 1 to a ladder stabiliser described in WO 02/059446 which describes a pair of stabilisers 10 and 10a which are supporting ladder 50. There is also shown supporting feet 15 and 15a of each stabiliser 10 and 10a. Two threaded rods 17 are inserted through a pair of aligned apertures 20 and 25 located on each tubular housing 16 and 16a respectively as shown. Each of apertures 20 and each of apertures 25 extend through spacers 11 and 12 respectively. The threaded rods 17 also are inserted through apertures 9 on each ladder upright 51 and 51a and thus extend through hollow ladder rungs 53 and 54 respectively. Movable locking nuts 18 are threaded onto each rod 17 at each end to securely fasten each of tubular housings 16 and 16a to respective outer sides of ladder uprights 51 and 51a.

FIG. 1 also shows telescopic extension of inner members or telescopic legs 14 and 14a within respective housings 16 and 16A.

Each of legs 14 and 14a are retained within an adjacent housing 16 and 16A by pin assemblies 13 which extend through a plurality of spaced apertures 21 and 21a located on each telescopic leg 14 and 14a. To adjust each leg 14 and 14a as required pin assembly is pulled outwardly and removed from each aperture 21 and 21a to facilitate movement of each leg 14 and 14a within tubular housings 16 and 16a as required. A more detailed view of pin assembly 13 is shown in FIG. 4.

Insofar as the method of manufacture of each stabiliser 10 or 10a as shown in FIG. 1 as well as FIG. 2, it was necessary to weld each of spacers 11 and 12 to an adjacent outer surface of each housing 16 and 16a.

However it will be noted that each housing 16 and 16a is of square tubular shape and is preferably formed from aluminium. It has now been found in practice that fillet welding is the desirable welding process of choice and was selected over other conventional methods of welding such as spot welding, butt welding, TIG welding, MIG welding or fusion welding.

However in relation to the tubular housings 16 and 16a having regard to the preferred grade of aluminium which is 6060 or 6061 which was chosen for the purpose of non corrosion and ease of machining and bearing in mind the choice of 32 mm×3 mm box section tube it was found that extreme care was required in fillet welding each of spacers 11 and 12 to tubular housing 16 and 16a. It was found regardless of cross sectional shape of the spacer 11 and 12 (e.g. FIG. 1 shows a square section while FIGS. 2 to 3 show a round cross section) that a fillet weld had to be applied to the top and bottom of each spacer 11 and 12 as shown in FIGS. 3 and 7.

Applying a fillet weld completely around the periphery or circumference of each spacer 11 and 12 only resulted in deformation of the square aluminium tube. A more detailed view of the location of each fillet weld is shown in FIG. 7 and thus application of excess welds to each of spacers 11 and 12 about the periphery thereof has to be avoided at all costs.

In FIG. 2 is shown stabiliser 10 having tubular housing 16, spacers 11 and 12 and pin assembly 13 as well as foot attachment mechanism 7.

In FIG. 3 there is shown tubular housing 16 having spacers 11 and 12 extending outwardly therefrom having a cylindrical shank 7, round flange 8 and hollow tubular lug 6 for receiving an outer end of a threaded rod 17. Fillet welds 31 and 32 are applied at the top and bottom of each spacer as shown.

FIG. 4 shows a detail of pin assembly 13 showing pin head 33, recess 34, pin housing 35 having hollow bore 36 and attachment apertures 37. There is also provided pin 38 having spring 39, spring retainer 40 and screw threaded end 41 for insertion into hollow bore 36 and engagement with recess 34 of pin head 33. It is important that spring 39 be located on pin 38 before insertion of pin 38 into hollow bore 36.

FIG. 5 also shows further details of the foot 15 and attachment mechanism 5 wherein a bolt 43 is inserted through mating bore 44 in each leg 14 and locked in position by nut 45. The foot 15 includes a base 46 and a swivel insert 47 which is retained within mating recess 48.

FIGS. 2, 5 and 6 show another important feature of the method of the invention involving the formation of a groove 49 in telescopic leg 14 which facilitates formation of apertures 21 in telescopic leg 14. There is also shown a plug stop 22 in tubular leg 14 in FIG. 6.

In FIG. 7 there is also shown the position of fillet welds 31 and 32 on tubular housing 16 having regard to welding of spacers 11 and 12 to right hand tubular housing 16 and left hand tubular housing 16a described in FIG. 1. It is essential that fillet welds 31 and 32 be located top on bottom of spacers 11 and 12 as shown in FIG. 7 because if for example the fillet welds were at the side of spacers 11 and 12 this would reset in deformation of tubular housing 16 and impair satisfactory functioning of movement of telescopic leg 14 in tubular housing 16.

In FIGS. 8 to 11 there is described an alternative embodiment to the embodiment of FIGS. 5 to 6 wherein groove 49A stops short of top end 56 of telescopic leg 14 as shown. The groove is suitably 10-20% of the height or thickness of telescopic leg 14 and preferably is 16% of the height of leg 14. This is shown in FIG. 10.

It is extremely important that all holes 21 are formed or drilled in the exact centre of groove 49 or 49A as shown by line 55 in phantom in FIG. 8.

In FIGS. 12 to 13 a detailed view of fillet welds 31 and 32 are provided in relation to a spacer 11 or 12 having an internal bore 60 together with aperture 61 for mounting of lug 6. The sectional view in FIG. 12 shows the shape of welds 31 and 32 and FIG. 13 shows the length of welds 31 and 32. FIG. 14 shows the shape of a typical fillet weld.

FIG. 16 shows a perspective view of telescopic leg 14 showing groove 49, holes 21 and plug stop 22. FIG. 15 shows a longitudinally sectional view of the top end 56 of telescopic leg 14 showing that plug 22 extends above holes 21 to function as an effective stop and thus prevent withdrawal of telescopic leg 14 from tubular housing 16.

FIGS. 17 to 18 relate to the foot 15 and in particular the attachment of insert 47 to base 46. Insert 47 has a pair of bottom holes or passages 62 which during the moulding process are filled with settable material to retain insert 47 totally within base 46.

Base 46 is also provided with a bottom corrugated surface 63 to retain a secure hold on a support surface (not shown). There is also provided aperture 64 for insertion of bolt 43.

Important features of the stabiliser 10 of the invention include:

(i) The telescopic inner adjustable leg 14 has unique features in that the shape of the leg and positioning of the holes 21 is very important. The depth, size, number of holes and the space between each hole are crucial for the exact smooth working of the leg 14 when in use. A full extension stopper and theft prevention has been allowed for in the positioning of a plug 22 at an exact location at the top of the leg 14.

(ii) The design of the large polyurethane non slip foot 15 has a unique feature of an aluminium insert 47 which has three important holes drilled at relevant locations, i.e. hole 64 to allow perfect swivel movement once installed to the telescopic leg 14 and a pair of holes 62 is to enhance the bond between the polyurethane and the aluminium insert which prevents the foot from being ripped away from the insert.

(iii) The spacers 11 and 12 are machined into a unique shape and design to allow for a number of key elements, i.e. (1) to locate the threaded rod 17 and house the lock nut 18 at installation; (2) to allow movement of the ladders rope action and pulley system; (3) to facilitate an amount of weld 31 and 32 so that smooth operation and a world standard of retro fit is achieved; and (4) to facilitate extension of lug 6 which may have a diameter of 15 mm into a rung of, for example, 10 mm to provide shear strength on fibreglass chemically bonded rungs, and alignment with the styles or uprights 51 and 51a of the ladder. Also the threaded rod 17 used to fix the stabiliser 10 onto the ladder has the ability to be cut to a varied length to match the width of the ladder rung and has enough surface area to cover the existing holes 9 in the styles of the ladder after fitting.

1. A method of forming a lug or spacer on a tubular housing of a ladder stabiliser for supporting a ladder, said lug or spacer being welded to an adjacent surface of the tubular housing only at a top location and bottom location respectively as a fillet weld which avoids deformation of the tubular housing and facilitates satisfactory operation of the stabiliser in use.

2. A method as claimed in claim 1 wherein the lug or spacer is round in cross section.

3. A method as claimed in claim 1 wherein the lug or spacer is square in cross section.

4. A method as claimed in claim 1 wherein the tubular housing is formed from aluminium.

5. A method as claimed in claim 4 wherein the aluminium is 6060 or 6061 grade.

6. A method as claimed in claim 5 wherein the size of the tubular housing is 32×3 mm square tube.

7. A tubular housing for use as a component of a ladder stabiliser when formed by the method of claim 1.

8. A ladder stabiliser which has a tubular housing and a telescopic leg which is movable within a hollow bore of the housing, said telescopic leg having a plurality of holes for co-operating with securing means to maintain the housing at a suitable height when in use for supporting a ladder, characterised in that said telescopic leg is formed with an integral locating groove wherein each of the plurality of holes is located so that they are in the exact centre width wise of the telescopic leg or coincide with a longitudinal axis of the hollow leg.

9. A ladder stabiliser as claimed in claim 8 wherein a plug stop is provided at a top position in use of said telescopic leg.

10. A method of manufacture of a telescopic leg for use in a ladder stabiliser, said telescopic leg being movable within a hollow bore of a mating housing, said telescopic leg having a plurality of holes for co-operating with securing means to maintain the housing at a suitable height when in use for supporting a ladder, characterised in that said telescopic leg is formed with an integral locating groove wherein each of the plurality of holes is located so that they are in the exact centre width wise of the telescopic leg or coincide with a longitudinal axis of the hollow lug.
